(19) United States
(12) Patent Application Publication
(10) Pub. No.: US 2025/0104019 A1
(43) Pub. Date: Mar. 27, 2025

(54) SYSTEM FOR ENABLING SCHEDULING AN APPOINTMENT BASED ON CATEGORY AND PRIORITY LEVEL OF USERS

(71) Applicant: Kishore Daggubati, Danville, CA (US)

(72) Inventor: Kishore Daggubati, Danville, CA (US)

(21) Appl. No.: 18/471,327

(22) Filed: Sep. 21, 2023

(51) Int. Cl. G06Q 10/1093; H04L 9/40

(52) U.S. Cl. CPC G06Q 10/1095; H04L 63/08

(57) ABSTRACT

A system for enabling scheduling an appointment based on category and priority level of users is disclosed. The system comprises of a first data processing system associated with a first user, a second data processing system associated with a second user, and a server. The server is configured to categorize plurality of users into plurality of groups based on a first input received from the first user and assign a priority level to each of the categorized groups based on a second input received from the first user. Further, display availability status of the first user to the second user based on the categorized groups and the priority level assigned to the categorized groups and enable the second user to schedule appointment with the first user based on category of the group associated with the second user and the priority level assigned to said category of the group.

### FIELD OF THE INVENTION

This application relates generally to the field of digital calendar systems and methods for scheduling appointments, and more particularly, to a novel approach for scheduling appointments in digital calendars wherein users are categorized into groups and appointment availability is determined based on priority levels assigned to said groups.

### BRIEF STATEMENT OF THE PRIOR ART

Digital calendars have become ubiquitous tools for managing personal and professional schedules. Traditional digital calendars typically allow users to schedule appointments with specific time slots and invite participants, but often do not consider the diverse needs and priorities of different user groups. Users are often required to manually assess their own availability and that of others, leading to inefficiencies and conflicts in scheduling appointments.

Existing solutions in the field of digital calendar scheduling may include basic algorithms for finding overlapping time slots among participants or utilizing free/busy status information. However, these approaches lack sophistication in handling scenarios where users belong to different priority groups with varying degrees of importance or urgency for specific appointments. Furthermore, some prior art systems may incorporate group calendars to a certain extent, but they often fail to provide a dynamic and adaptive mechanism for scheduling appointments, especially when dealing with multiple user groups with distinct priority levels.

Therefore, there is a need for an innovative approach that leverages categorized user groups and priority levels to efficiently schedule appointments while considering the constraints and preferences of each group.

### SUMMARY OF THE INVENTION

In an embodiment, a system for enabling scheduling an appointment based on category and priority level of users is disclosed. The system comprises a first data processing system associated with a first user, a second data processing system associated with a second user, and a server. Upon establishing a secured connection between the first data processing system and the second data processing system, the server comprising at least one processor is configured to categorize plurality of users into plurality of groups based on a first input received from the first user and further assign a priority level to each of the categorized groups based on a second input received from the first user. Further, display availability status of the first user to the second user based on the categorized groups and the priority level assigned to the categorized groups and enable the second user to schedule appointment with the first user based on category of the group associated with the second user and the priority level assigned to said category of the group.

### BRIEF DESCRIPTION OF DRAWINGS

Embodiments are illustrated by way of example and not limitation in the figures of the accompanying drawings, in which like references indicate similar elements and in which:

FIG. 1 illustrates a system 100 for enabling scheduling an appointment based on category and priority level of users, in accordance with an embodiment.

FIG. 2 is a block diagram illustrating a first data processing system 102, in accordance with an embodiment.

FIG. 3 is a block diagram illustrating a second data processing system 106, in accordance with an embodiment.

FIG. 4 is a block diagram illustrating architecture of a server 110, in accordance with an embodiment.

FIG. 5 is a flowchart 500 illustrating the steps involved in scheduling an appointment based on category and priority level of users, in accordance with an embodiment.

FIG. 6 illustrates a block diagram depicting the categorization of groups and assignment of priority level, in accordance with an example embodiment.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practised without these specific details. In other instances, well-known methods, procedures and components have not been described in detail so as not to unnecessarily obscure aspects of the embodiments. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

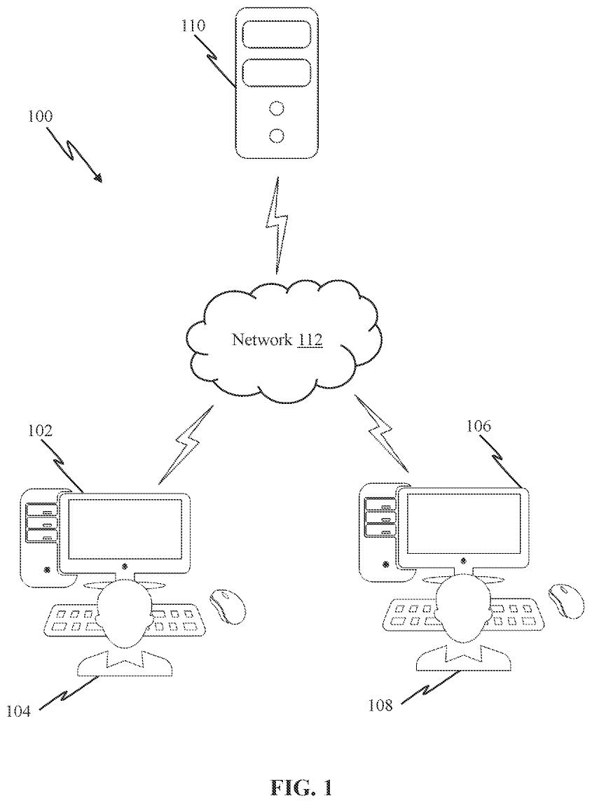

FIG. 1 illustrates a system 100 for enabling scheduling an appointment based on category and priority level of users, in accordance with an embodiment. The system 100 may comprise of a first data processing system 102, a second data processing system 106, a server 110, and a network 112. The first data processing system 102 may be associated with a first user 104. The second data processing system 106 may be associated with a second user 108. The server 110 may be configured to coordinate a secured connection between the first data processing system 102 and the second data processing system 106. The first data processing system 102, the second data processing system 106, and the server 110 may further be connected via the network 112, wherein the network 112 enables communication between them. The network 112 may be, but not limited to, a local area network, wide area network or a metropolitan area network.

In another embodiment, the system 100 may comprise a third data processing system, a fourth data processing system, and so on, wherein the third data processing system may be associated with a third user, the fourth data processing system may be associated with a fourth user, and so on (not shown in the figures).

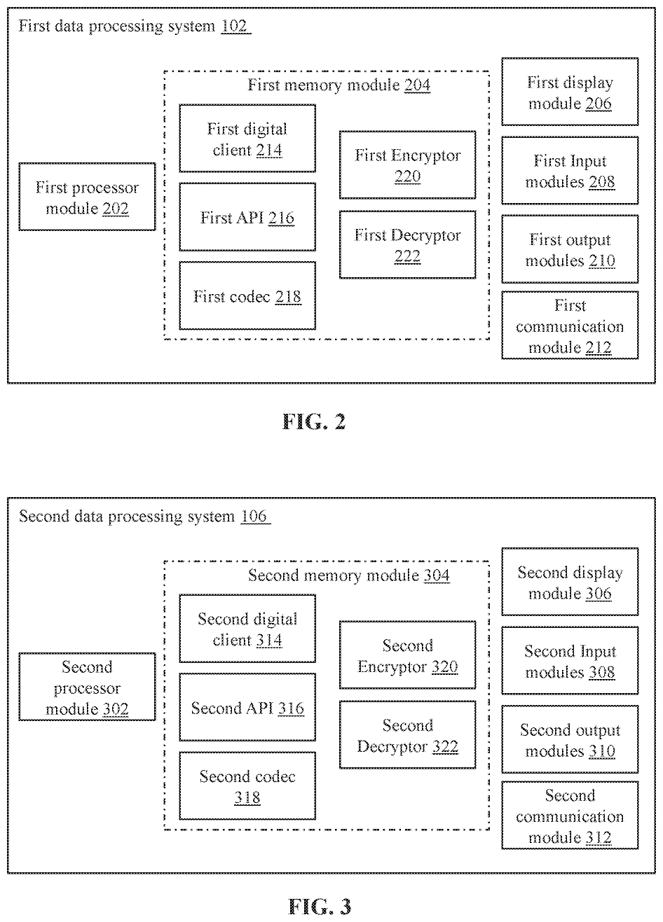

FIG. 2 is a block diagram illustrating the first data processing system 102, in accordance with an embodiment. The first data processing system 102 may comprise a first processor module 202, a first memory module 204, a first display module 206, first input modules 208, first output modules 210 and a first communication module 212.

The first processor module 202 may be implemented in the form of one or more processors and may be implemented as appropriate in hardware, computer-executable instructions, firmware, or combinations thereof. Computer-executable instruction or firmware implementations of the first processor module 202 may include computer-executable or machine-executable instructions written in any suitable programming language to perform the various functions described.

The first memory module 204 may include a permanent memory such as hard disk drive, may be configured to store data, and executable program instructions that are implemented by the processor module. The first memory module 204 may be implemented in the form of a primary and a secondary memory. The first memory module 204 may store additional data and program instructions that are loadable and executable on the first processor module 202, as well as data generated during the execution of these programs. Further, the first memory module 204 may be a volatile memory, such as random-access memory and/or a disk drive, or a non-volatile memory. The first memory module 204 may comprise of removable memory such as a Compact Flash card, Memory Stick, Smart Media, Multimedia Card, Secure Digital memory, or any other memory storage that exists currently or may exist in the future.

In an embodiment, the first memory module 204 may further comprise a first digital client 214, a first Application Programming Interface (API) 216, a first codec 218, a first encryptor 220 and a first decryptor 222. The first digital client 214 may be a web browser or a software application that enables video conferencing, wherein the first digital client 214 may further comprise a first digital client display interface. The first digital client display interface may enable the interaction of the first user 104 with the first data processing system 102. The first codec 218 may include computer-executable or machine-executable instructions written in any suitable programming language to compress outgoing data and decompress incoming data. The first encryptor 220 may encrypt the data being sent and first decryptor 222 may decrypt any encrypted incoming data.

The first display module 206 may display an image, a video, or data to a user. For example, the first display module 206 may include a panel, and the panel may be an LCD, LED or an AM-OLED.

The first input modules 208 may provide an interface for input devices such as keypad, touch screen, mouse, and stylus among other input devices. In an embodiment, the first input module 208 includes a camera and a microphone.

The first output modules 210 may provide an interface for output devices such as display screen, speakers, printer, and haptic feedback devices, among other output devices.

The first communication module 212 may be used by the first data processing system 102 to communicate with the server 110. The first communication module 212, as an example, may be a GPRS module, or other modules that enable wireless communication.

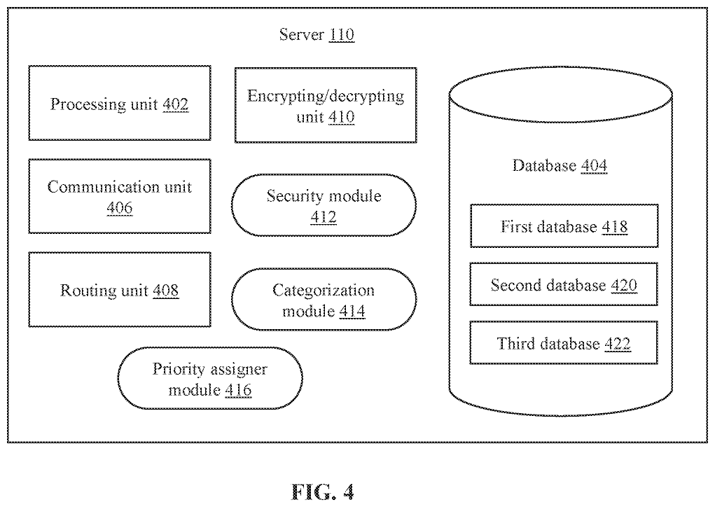

FIG. 3 is a block diagram illustrating a second data processing system 106, in accordance with an embodiment. The second data processing system 106 may comprise of a second processor module 302, a second memory module 304, a second display module 306, second input modules 308, second output modules 310 and a second communication module 312.

It may be noted that the second data processing system 106, may have a similar architecture as that of the first data processing system 102, and is therefore the details are not repeated for the sake of brevity.

In an embodiment, the third data processing system, the fourth data processing system, and so on, may have a similar architecture as that of the first data processing system 102.

FIG. 4 is a block diagram illustrating an architecture of the server 110, in accordance with an embodiment. The server 110 may comprise a processing unit 402, a database 404, a communication unit 406, a routing unit 408, an encrypting/decrypting unit 410, a security module 412, a categorization module 414, and a priority assigner module 416.

The processing unit 402 may be implemented in the form of one or more processors and may be implemented as appropriate in hardware, computer-executable instructions, firmware, or combinations thereof. Computer-executable instruction or firmware implementations of the processing unit 402 may include computer-executable or machine-executable instructions written in any suitable programming language to perform the various functions described.

The database 404 may include a permanent memory such as hard disk drive, that may be configured to store data, and executable program instructions that are implemented by the processor module. The database 404 may comprise of a first database 418, a second database 420, and a third database 422.

In one embodiment, the first database 418 may be configured to store information related to the first user 104, the second user 108, the third user, and so on, which may be, but not limited to, email ID, phone number of the users, information pertaining to the first data processing system 102, the second data processing system 106, third data processing system and so on.

The communication unit 406 may be used by the server 110 to communicate with the first data processing system 102 and the second data processing system 106. The communication unit 406, as an example, may be, but not limited to, a GPRS module, or other modules that enable wireless communication.

In an embodiment, the communication unit 406 may be used by the server 110 to communicate with the first data processing system 102 and the second data processing system 106, third data processing system, fourth data processing system, and so on.

The routing unit 408 may be configured to enable identification of data processing systems to which the data must be transmitted.

The encrypting/decrypting unit 410 may be configured to decrypt any encrypted incoming data from each of the data processing systems and encrypt the outgoing data from the server 110.

The security module 412 may be configured to authenticate each of the plurality of users associated with each of the data processing systems before establishing a connection.

The categorization module 414 may be configured to categorize plurality of users into plurality of groups (multiple groups) based on a first input received from the first user 104.

The priority assigner module 416 may be configured to assign a priority level to each of the categorized groups based on a second input received from the first user 104.

In an embodiment, the server 110 may be configured to display, on the second data processing system 106, availability status of the first user 104 to the second user 108 based on the categorized groups and the priority level assigned to the categorized groups. Further, the server 110 may be configured to enable the second user 108 to schedule appointment with the first user 104 based on category of the group associated with the second user 108 and the priority level assigned to said category of the group.

In an embodiment, the availability status of the first user 104 may comprise any one of Available, Away, Busy, Do Not Disturb, and Offline.

In an embodiment, the server 110 may be configured to create a virtual room, and a virtual lounge that may be associated with the virtual room, wherein the virtual room may be uniquely associated with the first user 104. Further, the server 110 may be configured to provide access to the second user 108 into the virtual lounge of the virtual room upon establishing the secured connection between the first data processing system 102 and the second data processing system 106. When availability status of the first user 104 is other than Available, the server 110 may be configured to allow the second user 108 to schedule the appointment with the first user 104 based on the category of the group associated with the second user 108 and the priority level assigned to said category of the group, wherein the appointment may be for a digital meeting.

In an embodiment, the server 110 may comprise of a digital calendar (or may be referred to as calendar). The digital calendar may be configured to synchronize meta data, wherein the meta data may comprise, but not limited to, information of the categorized groups and the priority level assigned to the categorized groups associated with the first user 104. This synchronizing of the meta data with the digital calendar allows the server to reflect the availability of the first user 104 on the digital calendar, when the second user 108 tries to schedule the appointment.

In an embodiment, upon receiving an appointment request from the second user 108, the server 110 may be configured to retrieve the category of the group associated with the second user 108. Further, the server 110 may be configured to retrieve the availability of the first user 104, and the availability of the second user 108 based on the category of the group associated with the second user 108 for the digital meeting. The availability of the first user 104 may be displayed to the second user 108 based on the category of the group associated with the second user 108 and the priority level assigned to said category of the group.

In an embodiment, the server 110 may allow the second user 108 to select an available time slot within the calendar for scheduling the digital meeting with the first user 104, wherein the available time slots are displayed based on the categorized groups and the priority level assigned to the categorized groups.

In an embodiment, the server 110 may be configured to display the availability status of the first user 104 as Busy, if the first user 104 rejects a request of the second user 108 to access the virtual room, or the first user 104 is engaged in digital meeting with a third user in the virtual room. Further, the server 110 may be configured to allow the second user 108 to request the appointment based on the category of the group associated with the second user 108 and the priority level assigned to said category of the group.

In an embodiment, the server 110 may be configured to notify the first user 104 of the appointment scheduled by the second user 108 via an Email, text message or call.

In an embodiment, the server 110 may be configured to allow the first user 104 to re-schedule the appointment scheduled by the second user 108 and further notify the second user 108 of the re-scheduled appointment.

In an embodiment, the server 110 may be configured to notify the second user 108 of the re-scheduled appointment via an Email, text message or call.

In an embodiment, the server 110 may be configured to request the second user 108 for a third input, wherein the third input may comprise of a duration for the appointment requested by the second user 108. Further the server 110 may display the available time slots to the second user 108 based on the third input, category of the group associated with the second user 108 and the priority level assigned to said category of the group.

In an embodiment, if an appointment is already scheduled between the second user 108 and the first user 104, and the fourth user associated with any one of categorized groups with priority level higher than the priority level of the categorized group associated with the second user 108 requests to schedule appointment with the first user 104, the server 110 may be configured to notify the first user 104 of the request by the fourth user to schedule the appointment. Further, the server 110 may be configured to allow the first user 104 to re-schedule the appointment scheduled by the second user 108 and notify the second user 108 of the re-scheduled appointment.

In another embodiment, if the fourth user associated with the same categorized group as that of the second user 108 requests to schedule appointment with the first user 104 when an appointment is already scheduled between the second user 108 and the first user 104, the server 110 may be configured to notify the first user 104 of the request by the fourth user to schedule the appointment, allow the first user 104 to re-schedule the appointment scheduled by the second user 108, and notify the second user 108 of the re-scheduled appointment.

In an embodiment, the server 110 may be configured to disallow the second user 108 to schedule appointment with the first user 104 based on a predetermined threshold, wherein the predetermined threshold refers to number of appointments scheduled by the second user 108 with the first user 104 within a predefined time frame. For example, the first user 104 may set the predetermined threshold to be “3” for a period of a “week”, i.e., the server 110 may allow the second user 108 to schedule, at most, three appointments within the week's timeframe.

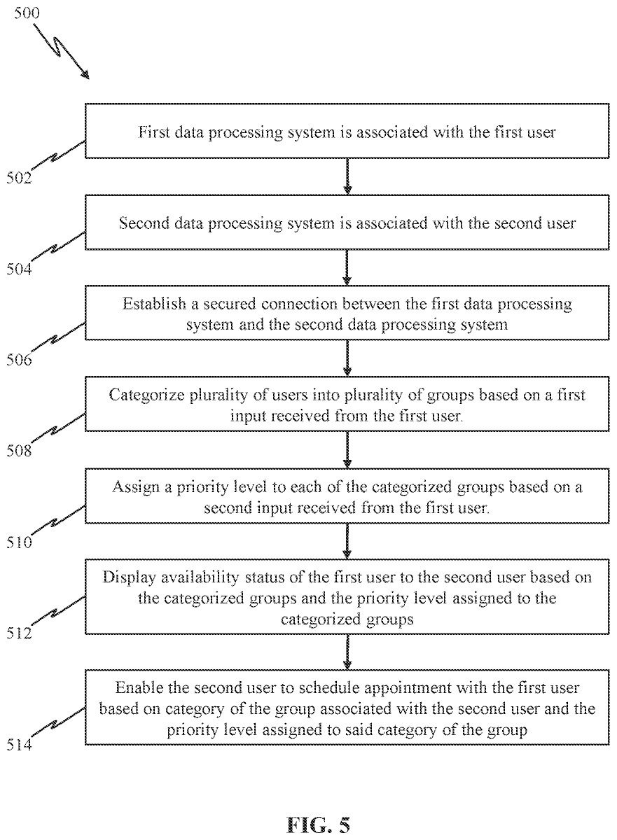

FIG. 5 is a flowchart 500 illustrating the steps involved in scheduling an appointment based on category and priority level of users, in accordance with an embodiment. At step 502, the first data processing system 102 is associated with the first user 104, wherein the first user 104 is authenticated. The first data processing system 102 is associated to the first user 104 when the first user 104 logs into the first data processing system 102 using his/her user credentials.

At step 504, the second data processing system 106 is associated with the second user 108, wherein the second user 108 is authenticated. The second data processing system 106 is associated to the second user 108 when the second user 108 logs into the second data processing system 106 using his/her user credentials.

At step 506, the server 110 may be configured to establish a secured connection between the first data processing system 102 and the second data processing system 106.

At step 508, the categorization module 414 may be configured to categorize plurality of users into plurality of groups based on the first input received from the first user 104. Functioning of the categorization module 414 is explained in the form of examples in later sections.

At step 510, the priority assigner module 416 may be configured to assign priority level to each of the categorized groups based on the second input received from the first user 104. Functioning of the priority assigner module 416 is explained in the form of examples in later sections.

At step 512, the server 110 may be configured to display on the second data processing system 106, availability status of the first user 104 to the second user 108 based on the categorized groups and the priority level assigned to the categorized groups.

At step 514, the server 110 may enable the second user 108 to schedule appointment with the first user 104 based on category of the group associated with the second user 108 and the priority level assigned to said category of the group.

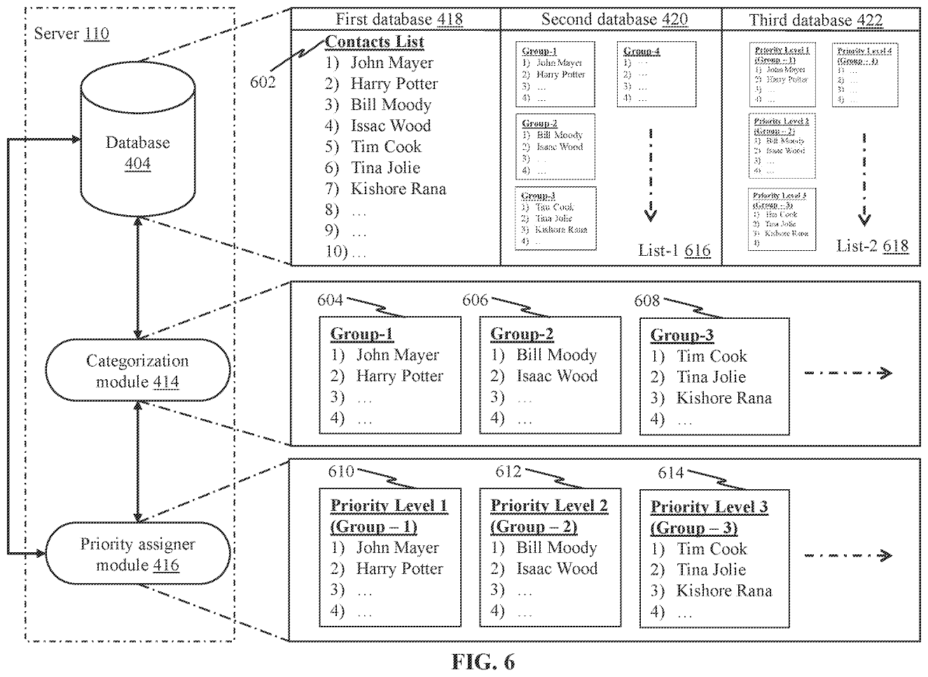

FIG. 6 illustrates a block diagram depicting the categorization of groups and assignment of priority level, in accordance with an example embodiment. The database 404 may be in communication with the categorization module 414 and the priority assigner module 416.

In an embodiment, the first database 418 may comprise of a Contacts List 602 comprising details of the plurality of users added by the first user 104. The details may include, but not limited to, email ID, and phone number of the plurality of users.

In an embodiment, the server 110 may be configured to import contacts of plurality of users into the Contacts List 602 from an image, a document, an online database, plurality of email services, or other social networking websites.

In the example embodiment, the Contacts List 602 may comprise of plurality of users, namely, John Mayer, Harry Potter, Bill Moody, Issac Wood, Tim Cook, Tina Jolie, Kishore Rana, and so on.

In an embodiment, the categorization module 414 may be configured to categorize the users in the Contacts List 602 into plurality of groups, such as, Group-1 604, Group-2 606, Group-3 608, and so on.

In the example embodiment, the categorization module 414 may be configured to categorize John Mayer and Harry Potter in Group-1 604, Bill Moody and Issac Wood in Group-2 606, Tim Cook, Tina Jolie, and Kishore Rana in Group-3 608, and so on.

In an embodiment, the second database 420 may comprise details of the plurality of groups categorized by the categorization module 414 in a List-1 616.

In an embodiment, the priority assigner module 416 may be configured to assign a priority level to each of the groups, such as, Priority Level-1 610 for Group-1 604, Priority Level-2 612 for Group-2 606, Priority Level-3 614 for Group-3 608, and so on. Priority Level-1 610 being considered higher than that of Priority Level-2 612.

In the example embodiment, the priority assigner module 416 may be configured to assign Priority Level-1 610 for Group-1 604 comprising John Mayer and Harry Potter, Priority Level-2 612 for Group-2 606 comprising Bill Moody and Issac Wood, Priority Level-3 614 for Group-3 608 comprising Tim Cook, Tina Jolie, and Kishore Rana, and so on.

In an embodiment, the third database 422 may comprise details of assigned priority levels, by the priority assigner module 416, to the plurality of groups categorized by the categorization module 414 in a List-2 618.

### Example-1

According to an example, let's assume that the first user 104 has set the availability status, for users of Group-1 604 and Group-2 606, to Available for designated time slots, from Monday to Friday between 0900 Hrs and 1700 Hrs. The availability status of Available will be displayed to Group-1 604 and Group-2 606 in the said time slots and the availability status of Busy will be displayed to users of Group-3 608 in the said time slots. John Mayer from Group-1 604 intends to schedule an appointment with the first user 104. The server 110 may be configured to display available time slots from the designated time slots for Group-1 604. John Mayer may choose the available time slot as per availability of self and the first user 104. The availability status of the first user 104 for users of Group-3 608 may be displayed as Available during the rest of the time or during another designated time slot, such as from Monday to Friday between 1700 Hrs and 1800 Hrs.

### Example-2

According to another example, let's assume that the first user 104 has set the availability status, for users of Group-1 604 and Group-2 606, to Available for designated time slots, i.e., from Monday to Friday between 0900 Hrs and 1700 Hrs. The availability status of Available will be displayed to Group-1 604 and Group-2 606 in the said time slots and the availability status of Busy will be displayed to users of Group-3 608 in the said time slots. Bill Moody from Group-2 606 has scheduled a meeting with the first on Wednesday between 1000 Hrs and 1700 Hrs. Now, John Mayer from Group-1 604 intends to schedule an appointment with the first user 104 on Wednesday between 1200 Hrs and 1400 Hrs. The server 110 may be configured to notify the first user 104 of the request by John Mayer to schedule the appointment. The server 110 may allow the first user 104 to cancel the appointment with Bill Moody and re-schedule the appointment to some other time slot. The sever 110 may notify Bill Moody about the re-scheduled appointment.

### Example-3

According to another example, let's assume that the first user 104 has set the availability status, for users of Group-1 604, to Available for designated time slots, from Monday to Friday between 0900 Hrs and 1700 Hrs. The availability status of Available will be displayed to Group-1 604 in the said time slots and the availability status of Busy will be displayed to users of groups Group-2 606 and Group-3 608 in the said time slots. John Mayer from Group-1 604 has scheduled a meeting with the first on Thursday between 0900 Hrs and 1700 Hrs. Now, Harry Potter from Group-1 604 intends to schedule an appointment with the first user 104 on Thursday between 1200 Hrs and 1400 Hrs. The server 110 may be configured to notify the first user 104 of the request by Harry Potter to schedule the appointment. The server 110 may then allow the first user 104 to cancel the appointment with john Mayer and re-schedule the appointment to some other time slot. The server 110 may notify john Mayer about the re-scheduled appointment.

### Example-4

According to another example, let's assume that the first user 104 has set the availability status, for users absent from the Contacts List 602, for example, people outside the organization (hereinafter customers), to Available for a designated time slot, from Monday to Friday between 1700 Hrs and 1800 Hrs. The server 110 may be configured to authenticate the customers and categorize the customers into a Group-X. The availability status of the first user 104 will be displayed as Available to Group-X for said time slots and the availability status of Busy will be displayed to the plurality of users of the Contacts List 602.

The processes described above is described as a sequence of steps, this was done solely for the sake of illustration. Accordingly, it is contemplated that some steps may be added, some steps may be omitted, the order of the steps may be re-arranged, or some steps may be performed simultaneously.

Although embodiments have been described with reference to specific example embodiments, it will be evident that various modifications and changes may be made to these embodiments without departing from the broader spirit and scope of the system and process or method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling scheduling an appointment based on category and priority level of users, the system comprising:
a first data processing system associated with a first user;
a second data processing system associated with a second user; and
a server, wherein,
when a secured connection is established between the first data processing system and the second data processing system, the server comprising at least one processor is configured to:
categorize plurality of users into plurality of groups (multiple groups) based on a first input received from the first user;
assign a priority level to each of the categorized groups based on a second input received from the first user;
display, on the second data processing system, availability status of the first user to the second user based on the categorized groups and the priority level assigned to the categorized groups; and
enable the second user to schedule appointment with the first user based on category of the group associated with the second user and the priority level assigned to said category of the group.

2. The system according to claim 1, wherein the availability status of the first user comprises Available, Away, Busy, Do Not Disturb and Offline.

3. The system according to claim 2, wherein the server is configured to:
create a virtual room, and a virtual lounge associated with the virtual room, wherein the virtual room is uniquely associated with the first user;
provide the second user, access to the virtual lounge of the virtual room upon establishing the secured connection between the first data processing system and the second data processing system, wherein when availability status of the first user is other than Available, the server is configured to:
allow the second user to schedule the appointment with the first user based on the category of the group associated with the second user and the priority level assigned to said category of the group, wherein the appointment is for a digital meeting.

4. The system according to claim 3, wherein the server comprises a calendar, wherein the server is configured to:
retrieve the category of the group associated with the second user;
retrieve the availability of the first user, and the availability of the second user based on the category of the group associated with the second user for the digital meeting; and
display the availability of the first user to the second user based on the category of the group associated with the second user and the priority level assigned to said category of the group.

5. The system according to claim 4, wherein the server allows the second user to select an available time slot within the calendar for scheduling the digital meeting with the first user, wherein the available time slots are displayed based on the categorized groups and the priority level assigned to the categorized groups.

6. The system according to claim 5, wherein the server is configured to display the availability status of the first user as Busy, when:
the first user rejects a request of the second user to access the virtual room; or
the first user is engaged in digital meeting with a third user in the virtual room.

7. The system according to claim 6, wherein the server is configured to allow the second user to schedule the digital meeting, when the availability status of the first user is displayed as Busy, based on the category of the group associated with the second user and the priority level assigned to said category of the group.

8. The system according to claim 1, wherein the server is configured to notify the first user of the appointment scheduled by the second user via an Email, text message or call.

9. The system according to claim 8, wherein the server is configured to:
allow the first user to re-schedule the appointment scheduled by the second user; and
notify the second user of the re-scheduled appointment.

10. The system according to claim 9, wherein the server is configured to notify the second user of the re-scheduled appointment via an Email, text message or call.

11. The system according to claim 1, wherein the server is configured to receive a third input from the second user, wherein the third input comprises of a duration for the appointment requested by the second user.

12. The system according to claim 1, wherein when,
the appointment is scheduled by the second user with the first user; and
a fourth user, associated with a categorized group with priority level higher than priority level of the categorized group associated with the second user, requests to schedule appointment with the first user, the server is configured to:
notify the first user of the request by the fourth user to schedule the appointment;
allow the first user to re-schedule the appointment scheduled by the second user; and
notify the second user of the re-scheduled appointment.

13. The system according to claim 1, wherein when,
the appointment is scheduled by the second user with the first user; and
a fourth user, associated with the same categorized group as that of the second user, requests to schedule appointment with the first user, the server is configured to:
notify the first user of the request by the fourth user to schedule the appointment;
allow the first user to re-schedule the appointment scheduled by the second user; and
notify the second user of the re-scheduled appointment.

14. The system according to claim 1, wherein the server is configured to disallow the second user to schedule appointment with the first user based on a predetermined threshold, wherein the predetermined threshold refers to number of appointments scheduled by the second user with the first user within a predefined time frame.

15. The system according to claim 1, wherein the system comprises of a security module, wherein the security module is configured to verify and authenticate the plurality of users.

16. The system according to claim 1, wherein the system comprises of a categorization module, wherein the categorization module is configured to categorise the plurality of users into plurality of groups based on the first input received from the first user.

17. The system according to claim 16, wherein the system comprises of a priority assigner module, wherein the priority assigner module is configured to assign each of the categorized groups with a priority level based on the second input received from the first user.

18. A method for enabling scheduling an appointment based on categorization and priority level of users, the method comprising:
associating, a first data processing system with a first user;
associating, a second data processing system with a second user;
establishing, by a server comprising at least one processor, a secured connection between the first data processing system and the second data processing system;
categorizing, by the server, plurality of users into plurality of groups based on a first input received from the first user;
assigning, by the server, a priority level to each of the categorized groups based on a second input received from the first user;
displaying, on the second data processing system, availability status of the first user to the second user based on the categorized groups and the priority level assigned to the categorized groups; and
enabling, by the server, the second user to schedule appointment with the first user based on category of the group associated with the second user and the priority level assigned to said category of the group.
